(19) United States
(12) Patent Application Publication
(10) Pub. No.: US 2004/0192406 A1
(43) Pub. Date: Sep. 30, 2004

(54) Antenna circuit and wireless communication device

(76) Inventors: Naoki Okazaki, Kawasaki (JP); Masaru Kanazawa, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/806,783

(22) Filed: Mar. 23, 2004

(30) Foreign Application Priority Data
Mar. 31, 2003 (JP) 2003-095158 (PAT.

(51) Int. Cl. H04B 1/38; H01Q 1/24

(52) U.S. Cl. 455/569.1; 455/575.7; 455/73

(57) ABSTRACT

The present invention relates to an antenna circuit that can achieve optimal matching according to an external environment of an antenna without interrupting communication in wireless transmission and reception. The antenna circuit of a cellular phone is provided with a plurality of matching circuits between a transmitting unit or a receiving unit and the antenna. A control unit detects operating conditions of the cellular phone such as a waiting mode, a normal voice call mode or a hands-free call mode as the external environment of the antenna. Each matching circuit has an impedance to optimize the antenna matching according to the respective conditions.

### CROSS-REFERENCE TO RELATED APPLICATION

This application claims the priority of Japanese Patent Application Number 2003-095158, filed on Mar. 31, 2003.

### BACKGROUND OF THE INVENTION

1. Field of the Invention

The present invention relates to an antenna circuit and a communication device that can automatically and optimally control antenna matching according to an external environment. The present invention is applied to fixed telephones and transportable wireless communication devices such as cellular phones, PHS (Personal Handyphone System) phones, PDA (Personal Digital Assistants) having wireless transmitting and receiving functions and the like, wherein automatic control is performed to optimize antenna matching that may deviate from an optimal state due to an external environment, such as a human body, so as to obtain stable antenna gains and to improve communication quality.

It is to be noted here that the transportable wireless communication devices described above will be hereinafter referred to as mobile wireless communication devices.

2. Description of the Related Art

In a conventional wireless communication device, in order to perform optimal wireless communication, an antenna matching circuit is connected between an antenna and a transmitting/receiving unit. However, in the case of a mobile wireless communication device such as a cellular phone, typically, in circumstances such as when a call is started, the impedance of the antenna provided in the cellular phone varies as a human body touches or approaches the antenna. The gain of the antenna also varies accordingly. As a result, transmission power transmitted from the antenna of the cellular phone fluctuates significantly, which will lead to degradation of communication quality.

Therefore, in order to prevent the degradation of the communication quality, for example, in the case of a slave handset of a cordless phone, an internal circuit, which consists of a wireless transmitting/receiving circuit connected to the antenna, and a control circuit, and a switch are disposed in a housing of the slave handset so that the antenna is connected to a stub via the switch. When the impedance and, therefore, the gain of the antenna varies depending on the operating condition of the slave handset such as when a human body touches the antenna, the switch is turned to connect the antenna to the stub. It performs impedance matching between the antenna and the internal circuit so as to prevent the reduction of the transmission power for stable telephone conversations.

Further, in a PDA phone, a matching stub is connected to a feeding point at which an internal wireless circuit and a linear antenna unit are interconnected. Then, a manually switched stub group that is constituted by plural types of stubs and that is connected to the matching stub via plural types of contacts so that it can be switched in a rotary fashion. In this configuration, the manually switched stub group is turned on or off depending on whether a human body contacts the antenna or not.

However, in the cases described above, as the matching circuit is selected according to the magnitude of receiving electric field strength, the impedance of the antenna varies when a human body touches the antenna. Therefore, it is difficult to obtain constant transmission power by correcting the variation of the transmission power. Further, as the plural types of stubs, which are switched manually, instantaneously follow the variation of the transmission power due to the instantaneous variation of the antenna impedance, there is a problem in that degradation of the communication quality to some extent cannot be inhibited.

Consequently, an antenna circuit to solve this problem has been disclosed, for example, in the Japanese Unexamined Patent Publication (Kokai) H11-145852. In this antenna circuit, as a suitable matching circuit can be selected automatically according to the variation of the antenna impedance when a human body touches the antenna, communication can be performed with high quality and with a stable antenna gain. In this antenna circuit, one matching circuit is selected from a plurality of matching circuits provided in advance so that the reception level or transmission power is maximized.

On the other hand, a Time Division Multiple Access (TDMA) method is adopted as a communication method of mobile wireless communication devices such as cellular phones and, for example, in the case of Personal Digital Cellular (PDC) phones, in a wireless channel used by a plurality of users, a time period in which one radio frequency is used in one frame is divided into several time slots and the mobile wireless communication devices of each user perform communication using different time slots.

In the three-channel TDMA of the PDC type, a full rate call of a mobile phone consists of three time slots: a transmit slot T, a receive slot R, and an idle slot I. Then, as the timing of transmission at the base station is offset by about 1 ms, also in the receiving operation in the mobile phone, an idle time period of about 1 ms occurs before receiving a burst of the receive slot R. In the meanwhile, diversity branches are switched.

Therefore, when the antenna circuit described above is applied to the mobile wireless communication device of the PDC type, as the transmitting level is detected in the transmit slot T and the receiving level is detected in the receive slot R, respective matching circuits are selected for each of the transmit slot T and the receive slot R so that the transmitting and receiving levels are maximized.

However, because the selection by the switching control of a circuit switching unit is performed in either the transmit slot T or the receive slot R, transmit or receive data is lost at the time of switching and the transmitted and received call is interrupted. It means that the communication quality of the wireless transmission and reception is reduced.

Thus, it is an object of the present invention to provide an antenna circuit that can perform optimal impedance matching of antennas without interrupting communication in wireless transmission and reception, and a wireless communication device comprising such antenna circuit.

### SUMMARY OF THE INVENTION

In order to solve the problem described above, according to the present invention, there is provided an antenna circuit in which a plurality of matching circuits are switched to perform impedance matching of an antenna, wherein each of said matching circuits has an optimal impedance corresponding to a plurality of external environmental conditions affecting said antenna and the switching of said matching circuits is controlled according to the external environmental conditions of said antenna.

Then, said plurality of external environmental conditions include: a free space mode; a conductor or dielectric proximity mode; and a conductor or dielectric separation mode.

Further, according to the present invention, there is provided a wireless communication device comprising an antenna circuit that includes an antenna and matching circuits and switchably connects said antenna circuit to a transmitting unit or a receiving unit, wherein said antenna circuit has a plurality of the matching circuits having optimal impedances, each of which corresponds to a plurality of external environmental conditions affecting said antenna, and the switching of said matching circuits is controlled according to the external environmental conditions of said antenna.

Then, in the wireless communication device, said transmitting unit or receiving unit is switchably connected to said antenna circuit so as to perform mobile wireless communication, wherein said external environmental conditions detected by a detecting unit include: a call waiting mode; a voice call mode; and a hands-free call mode.

### BRIEF DESCRIPTION OF THE DRAWINGS

Other features, objects and advantages of the present invention will become apparent from the following description of preferred embodiments with reference to the drawings in which like reference characters designate like or corresponding parts throughout several views, and in which:

FIG. 1 is a block diagram for describing an embodiment in which an antenna circuit according to the present invention is applied to a mobile wireless communication device;

FIG. 2 is a flow chart for describing an operation of a control unit in the embodiment of the mobile wireless communication device comprising the antenna circuit according to the present invention;

FIG. 3 is a block diagram for describing an alternative embodiment in which an antenna circuit according to the present invention is applied to a mobile wireless communication device;

FIG. 4 is a flow chart for describing an operation of a control unit in the alternative embodiment of the mobile wireless communication device comprising the antenna circuit according to the present invention;

FIG. 5 is a block diagram for describing a mobile wireless communication device according to the prior art; and

FIG. 6 is a block diagram for describing an example in which the antenna circuit according to the prior art is applied to a mobile wireless communication device.

### DESCRIPTION OF THE PREFERRED EMBODIMENTS

Hereinafter, an embodiment of an antenna circuit and a wireless communication device according to the present invention will be described with reference to the drawings. First, before describing the antenna circuit of this embodiment, in order to clarify features and effects of this embodiment, an antenna circuit according to the prior art that underlies the antenna circuit of this embodiment will be described.

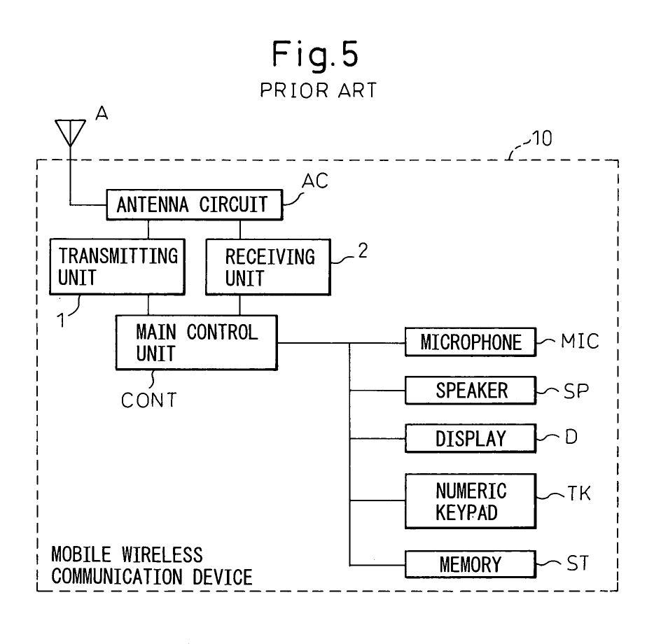

FIG. 5 schematically shows an entire block diagram of a-mobile wireless communication device in which the antenna circuit according to the prior art is built. In FIG. 5, a mobile wireless communication device 10 may be, for example, a cellular phone. The cellular phone typically comprises a microphone MIC, a speaker SP, a display device D, a numeric keypad TK for inputting telephone numbers and the like, and a memory ST for storing a telephone directory, e-mails and the like, which are controlled by a main control unit CONT. Further, in order to function as the cellular phone, it has an antenna A, an antenna circuit AC, a transmitting unit 1, and a receiving unit 2, wherein the main control unit CONT controls operations such as switching between the transmitting unit 1 and the receiving unit at the time of transmission/reception in the antenna circuit and allows the microphone MIC and the speaker SP to operate at the time of voice calls.

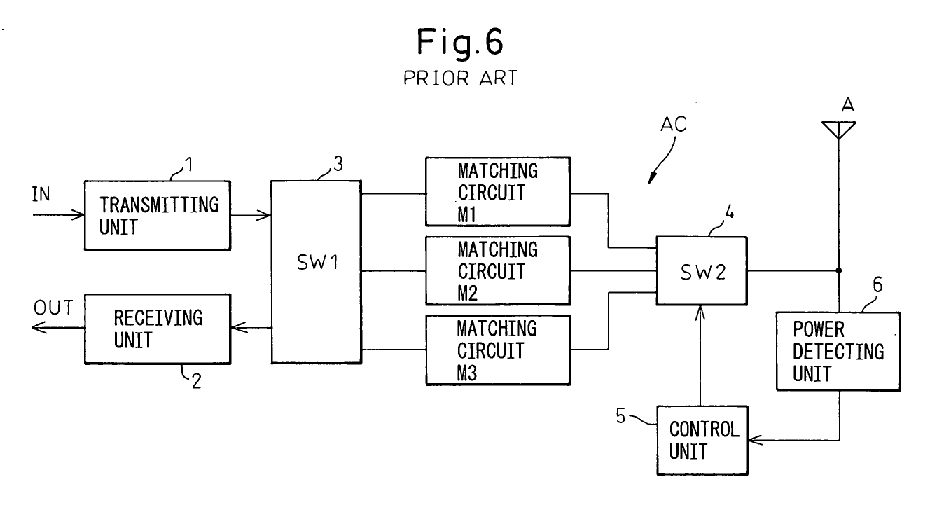

Then, FIG. 6 shows a specific example of the prior art antenna circuit that is used and proposed in the cellular phone configured as shown in FIG. 5. This antenna circuit comprises a transmission/reception switching unit 3 for switchably connecting the transmitting unit 1 and the receiving unit 2 to the antenna A, a plurality of matching circuits M1-M3 that have impedances different from each other and, further, perform impedance matching with the antenna A, and a circuit switching unit 4 for selecting said plurality of matching circuits M1-M3.

Further, this antenna circuit comprises a power detecting unit 6 for detecting a transmission power level of the antenna A for each matching circuit selected by the circuit switching unit 4. The control unit 5 may be included in the main control unit CONT.

Now, an operation of the antenna circuit AC configured as described above will be described. First, while the output power of the transmitting unit is always controlled to be constant, the transmission power is supplied to the plurality of matching circuits M1-M3 having impedances different from each other. The control unit 5 controls the circuit switching unit 4 to select the matching circuits sequentially. The transmission power of the transmitting unit 1 is fed to the antenna A through the selected matching circuits. For each of the selected matching circuits, the power detecting unit 6 detects the transmission power level of the antenna A and sends detection results to the control unit 5.

The control unit 5 compares the detection results by the power detecting unit 6 between the selected matching circuits and selects the matching circuit showing the maximum value of the transmission power level of the antenna A. The control unit 5 controls the switching operation of the circuit switching unit 4 based on the selection result. As described above, according to this antenna circuit AC, even if the impedance of the antenna varies and the gain of the antenna fluctuates as a human body or the like touches the antenna A, a suitable matching circuit can always be selected during transmission. Therefore, it is considered that the transmission power of the antenna can be prevented from fluctuating and the communication quality can be improved.

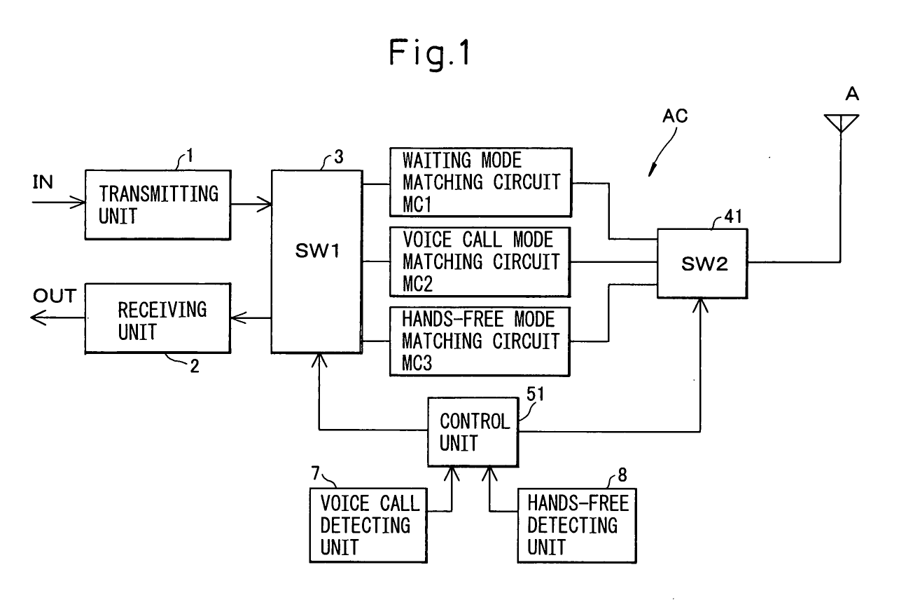

Next, an embodiment of a wireless communication device comprising an antenna circuit according to the present invention will be described with reference to FIG. 1.

In the prior art antenna circuit AC shown in FIG. 6, the plurality of matching circuits M1-M3 have impedances different from each other, and the control unit selects the matching circuit showing the maximum value of the transmission power level of the antenna and controls the switching operation of the circuit switching unit 4 based on the selection result.

When the prior art antenna circuit AC is applied, for example, to a cellular phone, even during a call, the impedance of an antenna varies depending on the operating condition by the user, such as, for example, a normal call mode in which the user holds the cellular phone by the hand, a hands-free mode in which the user does not hold the cellular phone by the hand during a call. Consequently, as the switching control of the matching circuits is performed during a call, transmission/reception data is lost. Therefore, in the case of the prior art antenna circuit AC, even if the communication is performed at an optimal level, the communication quality is reduced.

Therefore, the antenna circuit of this embodiment comprises a plurality of matching circuits having optimal impedances for each of a plurality of external environmental conditions in which the wireless communication device is used so that the communication can be performed at an optimal level and the degradation of the communication quality due to the data loss does not occur. Thus, the external environmental condition that is related to the antenna of the wireless communication device and affects the antenna impedance is detected and, based on the detection result, the plurality of matching circuits are selectively switched. In this configuration, the antenna matching can be optimized at the time when the external environmental condition of the wireless communication device is detected and, therefore, the need to switch the matching circuit while the wireless communication device is being used can be eliminated.

FIG. 1 shows an exemplary configuration of the antenna circuit of this embodiment applied to a cellular phone. In contrast to the prior art antenna circuit AC of FIG. 6 provided with the plurality of matching circuits M1-M3, which differ from each other only in impedances, in the case of this cellular phone, focusing attention on the fact that the gain of the antenna provided in the cellular phone varies depending on how close the user's body is to the cellular phone, there are provided matching circuits, which have impedances that can optimize the antenna gain according to the variation of the external environmental conditions and the number of which corresponds to the number of the external environmental conditions the antenna may experience.

The external environmental conditions are determined by the operating conditions of the cellular phone and the operating conditions include, for example, three modes such as a waiting mode, a voice call mode, and a hands-free mode. The waiting mode is a standby state in which there is no voice call and the voice call mode is a normal operating condition in which the user talks over the cellular phone while the user holds the cellular phone by the hand and presses the earphone or speaker part of the cellular phone against the ear. Further, the hands-free mode is a state in which the user talks at a distance from the cellular phone in a hands-free manner. According to these operating conditions of the cellular phone, the antenna circuit AC of FIG. 1 is provided with a waiting mode matching circuit MC1, a voice call mode matching circuit MC2, and a hands-free mode matching circuit MC3.

Here, as the antenna impedances corresponding to each external environmental condition differ little among individual users in each condition, the optimal impedances of the matching circuits can be designed easily according to the construction of the model of the used cellular phone.

These matching circuits MC1-MC3 are switched by a circuit switching unit 41 and connected to an antenna A. The circuit switching unit 41 is controlled by a control unit 51. The control unit 51 automatically controls the switching operation between the matching circuits MC1-MC3 according to the detected operating condition of the cellular phone. Here, it is to be noted that the control unit 51 is included in the main control unit CONT in the mobile wireless communication device 10 shown in FIG. 5.

The operating condition of the cellular phone is detected by a voice call detecting unit 7 and a hands-free detecting unit 8. These detecting unit 7 and 8 can be implemented by employing the functions inherently provided in the cellular phone. When the user's cellular phone receives an incoming call, the voice call detecting unit 7 detects that a button to start talking is pushed. If this button is pushed, it is determined that the cellular phone is in the normal voice call mode and, if there is no incoming call and such button is not pushed, it is determined that the cellular phone is in the waiting mode. Then, the hands-free detecting unit 8 determines that the cellular phone is in the hands-free mode when it detects that the hands-free mode is set in the pertinent cellular phone and the button to start the talk is pushed.

When the voice call detecting unit 7 detects that the pertinent cellular phone is in the waiting mode, the control unit 51 controls a switch SW2 in the circuit switching unit 41 so that the waiting mode matching circuit MC1 is connected to the antenna A. This is a state in which the antenna A is somewhat apart from a human body that is a conductor affecting the antenna impedance. In this case, the matching circuit MC1 is selected so that the optimal impedance matching is achieved between the transmitting unit 1 or the receiving unit 2 and the antenna A.

Next, when the pertinent cellular phone receives an incoming call and the voice call detecting unit 7 detects that the cellular phone is in the normal voice call mode, the control unit 51 controls the circuit switching unit 41 to automatically switch from the matching circuit MC1 to the matching circuit MC2. In this case, the human body that is a conductor to affect the impedance of the antenna A is close to the cellular phone so as to change the antenna impedance. Therefore, the optimal matching between the transmitting unit 1 or the receiving unit 2 and the antenna A is achieved by switching to the matching circuit MC2 having an optimal impedance that is determined under the assumption of this state in advance.

Further, when the hands-free detecting unit 8 detects that the cellular phone is in the hands-fee mode, the control unit 51 controls the circuit switching unit 41 to automatically switch to the hands-free mode matching circuit MC3. In this state, the body of the user who is talking over the cellular phone is considerably away from the antenna A. Therefore, as the antenna impedance is changed from the normal voice call mode, the optimal matching between the transmitting unit 1 or the receiving unit 2 and the antenna A is achieved by switching to the hands-free mode matching circuit MC3.

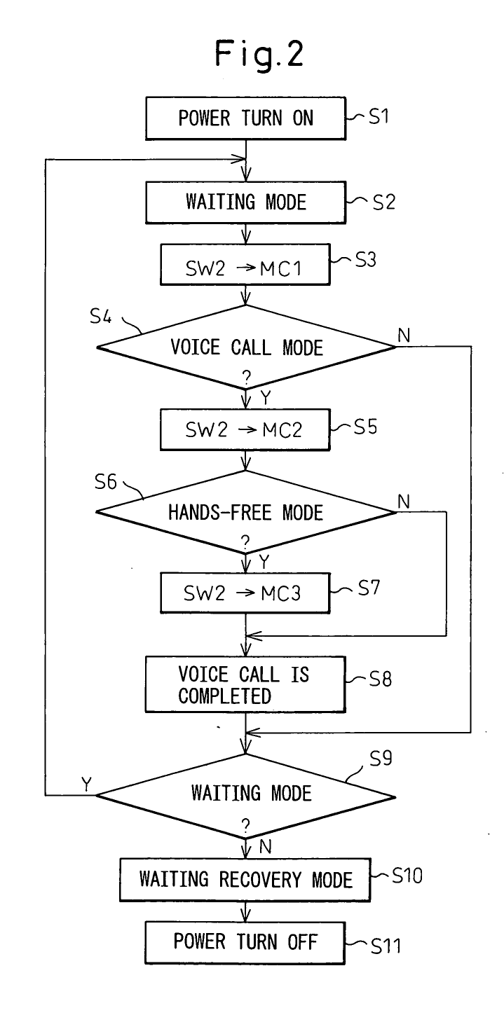

Then, FIG. 2 shows an operational flow chart of the switching control by the control unit 51 provided in the cellular phone as described above. Hereinafter, the operation of the control unit 51 will be described with reference to the flow chart of FIG. 2.

First, when the cellular phone is turned on (step S1), the control unit 51 determines that the transmission and reception of the cellular phone is in the waiting mode (step S2) and controls the switch SW2 in the circuit switching unit 41 so that the switch SW2 is switched to the waiting mode matching circuit MC1 (step S3).

Next, when the user makes a telephone call by using a numeric keypad TK and the like or receives a call from outside, the voice call detecting unit 7 detects that the cellular phone enters into the voice call mode. In response to the detection of the voice call mode (Y in step S4), the control unit 51 controls the switch SW2 to switch to the voice call mode matching circuit MC2 (step S5).

Here, the control unit 51 determines whether the cellular phone is used in the hands-free mode or not (step S6). When the hands-free detecting unit 8 detects that the cellular phone is in the hands-free mode (Y), the control unit 51 controls the switch SW2 to switch to the hands-free mode matching circuit MC3 (step S7). When the cellular phone is not in the hands-free mode but in the normal voice call mode (N), the switch SW2 remains on to connect to the voice call mode matching circuit MC2.

Next, when the voice call over the cellular phone is completed (step S8), the control unit 51 determines whether the cellular phone is in the waiting mode or not again (step S9). When the control unit 51 determines that the cellular phone is in the waiting mode (Y), the process returns to step S2, where the switch SW2 is controlled to switch to the waiting mode matching circuit MC1. On the other hand, in step S4, when it is determined that the cellular phone is not in the voice call mode (N in step S4), the control unit 51 also determines whether the cellular phone is in the waiting mode or not in step S9.

In step S9, when it is determined that the cellular phone is not in the waiting mode (N) or, for example, when the cellular phone is out of service range and telephone communication is impossible, the cellular phone turns into a waiting recovery mode (step S10). Then, when the user turns the cellular phone off, the operation of the control unit 51 terminates (step S11).

As described above, the antenna circuit AC of this embodiment is provided with a plurality of matching circuits having impedances, each of which is set so as to achieve the optimal matching between the transmitting unit or the receiving unit and the antenna in respective operating conditions or in either the waiting mode, the voice call mode, or the hands-free mode. Thus, as the suitable matching circuit is selectively connected according to the operating conditions, the problem in that the call is interrupted at the time of switching the matching circuits can be eliminated.

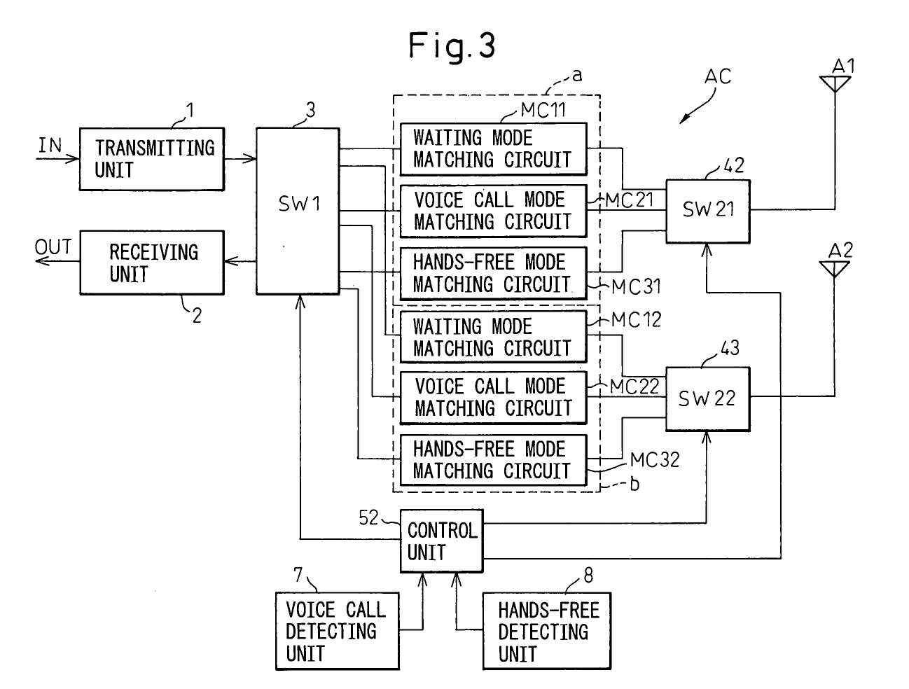

Though the antenna circuit AC of this embodiment that is applied to the cellular phone having one antenna is described hereinabove, some cellular phones may be equipped with another antenna additionally. The impedance of these antennas are determined by combining impedances of both antennas and, just as in the antenna circuit described above, varies according to the operating conditions of the cellular phone or depending on how close the users body, that is a conductor, is to the cellular phone. Therefore, an embodiment of an antenna circuit that is provided with a matching circuit that can achieve the optimal matching between transmitting/receiving unit and antennas according to the operating conditions of the cellular phone having two antennas is shown in FIG. 3.

The configuration of the antenna circuit AC in FIG. 3 is basically same as that of the antenna circuit AC in FIG. 1 but the cellular phone is equipped with two antennas consisting of an antenna A1 and an antenna A2. Therefore, two groups of matching circuits a and b corresponding to each antenna are provided. More specifically, the antenna A1 corresponds to the group a consisting of a waiting mode matching circuit MC11, a voice call mode matching circuit MC21, and a hands-free mode matching circuit MC31 and these matching circuits are switched by a circuit switching unit 42. Further, the antenna A2 corresponds to the group b consisting of a waiting mode matching circuit MC12, a voice call mode matching circuit MC22, and a hands-free mode matching circuit MC32 and these matching circuits are switched by a circuit switching unit 43.

Here, it is assumed that impedances of each matching circuit in the two groups a and b are set to optimal values for the pertinent antenna according to the operating conditions of the cellular phone or external environmental conditions of the antenna and in consideration of effects of a human body as a conductor as well as another antenna.

The operation of the antenna circuit AC shown in FIG. 3 is basically similar to that of the operation of the antenna circuit shown in FIG. 1. For example, when the pertinent cellular phone receives an incoming call and the transmission/reception is performed by using the antenna A1, if the voice call detecting unit 7 detects that the cellular phone is in the normal voice call mode, the control unit 52 controls the switch SW21 in the circuit switching unit 42 to connect the voice call mode matching circuit MC21 to the antenna A1. Here, if the antenna A2 is not used, the switch SW22 in the circuit switching unit 43 is turned off. At this time, the matching circuit MC21 is connected between the transmitting unit 1 or the receiving unit 2 and the antenna A1 so that the optimal matching is implemented in consideration of the effects of the antenna A2 and the human body.

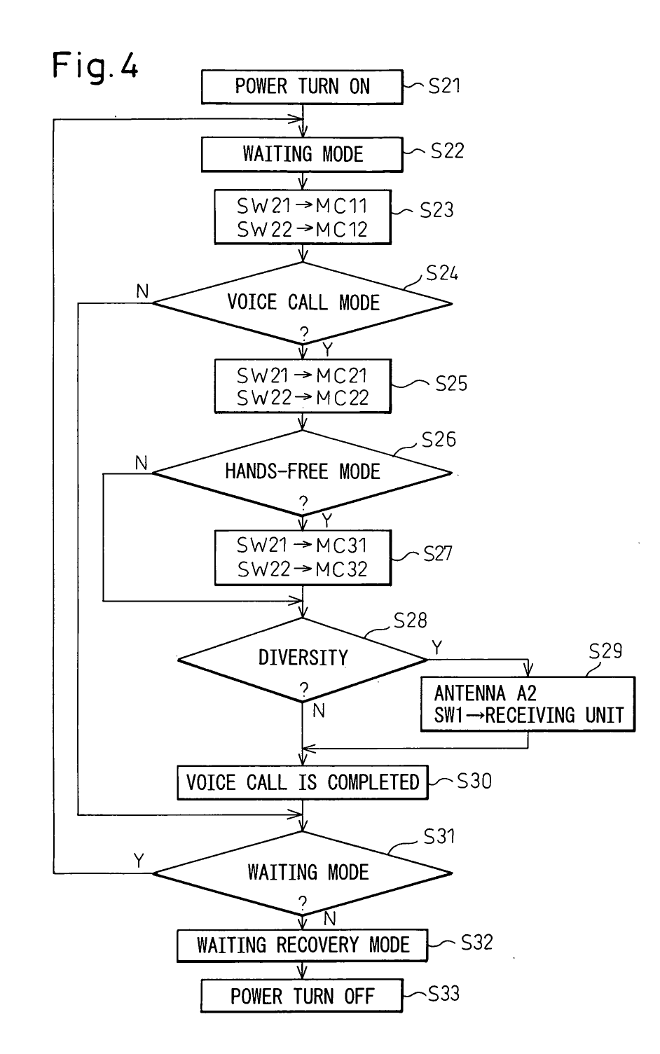

Then, FIG. 4 shows an operational flow chart of the switching control by the control unit 52 provided in the cellular phone as described above. Hereinafter, the operational control of the control unit 52 will be described with reference to the flow chart of FIG. 4.

First, when the cellular phone is turned on (step S21), the control unit 52 determines that the transmission and reception of the cellular phone is in the waiting mode (step S22) and, with regard to the group a, controls the switch SW21 in the circuit switching unit 42 so that the switch SW21 is switched to the waiting mode matching circuit MC11. Further, with regard to the group b, the control unit 52 controls the switch SW22 in the circuit switching unit 43 so that the switch SW22 is switched to the waiting mode matching circuit MC12 (step S23). At this time, the control unit 52 controls the switch SW1 in the transmission/reception switching unit 3 to switch to the antenna A1.

Next, when the user makes a telephone call by using a numeric keypad TK and the like or receives a call from outside, the voice call detecting unit 7 detects that the cellular phone enters into the voice call mode. In response to the detection of the voice call mode (Y in step S24), with regard to the group a, the control unit 52 controls the switch SW21 to switch to the voice call mode matching circuit MC21 and, further, with regard to the group b, controls the switch SW22 to switch to the voice call mode matching circuit MC22 (step S5).

Here, the control unit 52 determines whether the cellular phone is used in the hands-free mode or not (step S26). When the hands-free detecting unit 8 detects that the cellular phone is in the hands-free mode (Y), with regard to the group a, the control unit 52 controls the switch SW21 to switch to the hands-free mode matching circuit MC31 and, with regard to the group b, controls the switch SW22 to switch to the hands-free mode matching circuit MC32 (step S27). When the cellular phone is not in the hands-free mode but in the normal voice call mode (N), the switch SW21 and the switch SW22 remain to be connected to the voice call mode matching circuits MC21 and MC22, respectively.

In this connection, when diversity reception is performed by the two antennas A1 and A2 provided in the cellular phone during the voice call, the control unit 52 determines whether the cellular phone is in the diversity reception mode or not (step S28) and, when the cellular phone is in the diversity reception mode (Y), controls the switch SW1 in the transmission/reception switching unit 3 so that the matching circuits of the group b on the side of the antenna A2 are switched to the receiving unit 2 (step S29).

Next, when the voice call over the cellular phone is completed (step S30), the control unit 52 determines whether the cellular phone is in the waiting mode or not again (step S31). When the control unit 52 determines that the cellular phone is in the waiting mode (Y), the process returns to step S22, where the switch SW21 is controlled to switch to the waiting mode matching circuit MC11 and the switch SW22 is controlled to switch to the waiting mode matching circuit MC12. On the other hand, in step S24, when it is determined that the cellular phone is not in the voice call mode (N in step S24), the control unit 52 also determines whether the cellular phone is in the waiting mode or not in step S31.

In step S31, when it is determined that the cellular phone is not in the waiting mode (N) or, for example, when the cellular phone is out of service range and telephone communication is impossible, the cellular phone turns into a waiting recovery mode (step S32). Then, when the user turns the cellular phone off, the operation of the control unit 52 terminates (step S33).

In this connection, though the switching of the matching circuits of the both groups a and b is controlled simultaneously according to each operating condition in the operation of the control unit 52 shown in FIG. 4, for example, when the cellular phone is configured for the diversity reception, the switching of the matching circuits of the group b may be controlled according to the operating condition of the cellular phone at the time when the antenna A2 is used.

As described above, according to the antenna circuit of this embodiment, even when the cellular phone is equipped with two antennas, the optimal matching between the transmitting unit or the receiving unit and the antennas can be achieved in three operating modes such as the waiting mode, the voice call mode, and the hands-free mode and the problem in that the call is interrupted at the time of switching the matching circuits can be eliminated.

Further, for example, in connection with the display D such as an LCD provided in the cellular phone body, a brightness adjustment feature may be provided so as to make the display screen brighter when the brightness of the external environment is low and, inversely, to make the display screen darker when the brightness of the external environment is high. In such case, the cellular phone is provided with an optical sensor for detecting the brightness of the external environment. Therefore, by utilizing the operation of the optical sensor, it can be determined that the cellular phone is in the normal voice call mode when the optical sensor detects darkness and the user talks over the cellular phone. Based on the result of this determination, the control unit may select the matching circuit for the voice call mode.

Though the case in which the antenna circuit of this embodiment is applied to the cellular phone has been described hereinabove, its application is not limited to the cellular phone. For example, it may be applied to electronic equipment equipped with a mobile wireless communication device having an antenna, such as a Personal Digital Assistant.

When the external environment from the point of view of the antenna varies depending on how the user uses the pertinent electronic equipment and the variation affects the antenna impedance, the electronic equipment may be provided with matching circuits, which achieve the optimal matching according to the variation and the number of which corresponds to the number of the external environmental conditions. Then, a detecting unit for detecting the external environmental conditions may be provided and, based on the detection result, the switching of a plurality of the matching circuits may be controlled. This detecting unit may be implemented by employing the function provided in the electronic equipment inherently. Alternatively, a sensor for detecting the external environmental conditions may be provided separately and the switching of the matching circuits may be controlled automatically according to the output of the sensor. Further, the user may input information to control the switching of the plurality of matching circuits according to the operating conditions of the pertinent electronic equipment.

In this connection, it is to be noted that three operating conditions of the cellular phone such as the waiting mode, the voice call mode, and the hands-free mode have been exemplified in the above description. In connection with these three modes, when the antenna circuit of this embodiment is applied to the electronic equipment equipped with the mobile wireless communication device, the waiting mode may correspond to a free space mode, the voice call mode may correspond to a conductor or dielectric proximity mode in which the antenna impedance is affected, and the hands-free mode may correspond to a conductor or dielectric separation mode in which the antenna impedance is hardly affected.

Though the plurality of matching circuits that are configured to detect the three modes of the external environmental conditions in the antenna circuit of this embodiment are exemplified in the above description, the number of the external environmental conditions is not limited to the three modes and it may be two modes or, further, when there are a larger number of modes of the variation in the external environmental conditions of the antenna, the antenna circuit may be provided with matching circuits having optimal impedances, each of which corresponds to the respective modes, in advance and the suitable matching circuit may be selectively connected according to the detected external environmental condition.

As described above, according to the present invention, in an antenna circuit provided in a wireless communication device, matching circuits connected between a transmitting unit or a receiving unit and an antenna, which have optimal impedances corresponding to respective operating conditions of the wireless communication device and the number of which corresponds to the number of the operating conditions, are provided and the suitable matching circuit is selectively connected according to the detected operating condition.

Therefore, in wireless communication devices such as cellular phones and the like, the antenna matching can always be controlled optimally according to an external environment such as a human body affecting the antenna and, therefore, the antenna gain can be optimized and stabilized.

Further, according to the present invention, as a plurality of matching circuits provided in advance are selected according to the operating conditions of the wireless communication device and it is not necessary to continuously select the matching circuit that can provide the optimal matching, a call is not interrupted during the call over the pertinent wireless communication device. Further, an increase of current consumption due to the operation to select the matching circuits can be prevented.

What is claimed is:

1. An antenna circuit in which a plurality of matching circuits are switched to perform impedance matching of an antenna,
wherein each of said matching circuits has an optimal impedance corresponding to a plurality of external environmental conditions affecting said antenna and the switching of said matching circuits is controlled according to the external environmental conditions of said antenna.

2. An antenna circuit according to claim 1, wherein the switching of said matching circuits is controlled according to the detection of the external environmental conditions affecting the antenna.

3. An antenna circuit according to claim 2, wherein said plurality of external environmental conditions include: a free space mode; a conductor or dielectric proximity mode; and a conductor or dielectric separation mode.

4. An antenna circuit according to claim 3, having a plurality of antennas and, corresponding to each of said plurality of antennas, comprising a plurality of groups, each of which includes said plurality of matching circuits,
wherein said plurality of groups of the matching circuits are selected according to the use of the pertinent antenna.

5. An antenna circuit according to claim 4, wherein said plurality of matching circuits are provided in a mobile wireless communications device equipped with said antennas.

6. An antenna circuit according to claim 5, wherein said plurality of external environmental conditions include: a call waiting mode; a voice call mode; and a hands-free mode.

7. A wireless communication device comprising an antenna circuit that includes an antenna and matching circuits and switchably connects said antenna circuit to a transmitting unit or a receiving unit, wherein
said antenna circuit has a plurality of the matching circuits having optimal impedances, each of which corresponds to a plurality of external environmental conditions affecting said antenna, and
the switching of said matching circuits is controlled according to the external environmental conditions of said antenna.

8. A wireless communication device according to claim 7, wherein each of said matching circuits has a detecting unit for detecting the external environmental conditions affecting said antenna.

9. A wireless communication device according to claim 8, wherein the external environmental conditions detected by said detecting unit include: a free space mode; a conductor or dielectric proximity mode; and a conductor or dielectric separation mode.

10. A wireless communication device according to claim 9, wherein said transmitting unit or receiving unit is switchably connected to said antenna circuit so as to perform mobile wireless communication,
wherein said external environmental conditions detected by said detecting unit include: a call waiting mode; a voice call mode; and a hands-free call mode.

11. A wireless communication device according to claim 10, having a plurality of antennas and, corresponding to each of said plurality of antennas, comprising a plurality of groups, each of which includes said plurality of matching circuits,
wherein said plurality of groups of the matching circuits are selected according to the use of the pertinent antenna.

12. An antenna circuit according to claim 2, having a plurality of antennas and, corresponding to each of said plurality of antennas, comprising a plurality of groups, each of which includes said plurality of matching circuits,
wherein said plurality of groups of the matching circuits are selected according to the use of the pertinent antenna.

13. An antenna circuit according to claim 11, wherein said plurality of matching circuits are provided in a mobile wireless communications device equipped with said antennas.

14. An antenna circuit according to claim 12, wherein said plurality of matching circuits are provided in a mobile wireless communications device equipped with said antennas.

15. A wireless communication device according to claim 8, wherein said transmitting unit or receiving unit is switchably connected to said antenna circuit so as to perform mobile wireless communication,
wherein said external environmental conditions detected by said detecting unit include: a call waiting mode; a voice call mode; and a hands-free call mode.

16. A wireless communication device according to claim 15, having a plurality of antennas and, corresponding to each of said plurality of antennas, comprising a plurality of groups, each of which includes said plurality of matching circuits,
wherein said plurality of groups of the matching circuits are selected according to the use of the pertinent antenna.
